(19) United States
(12) Patent Application Publication
(10) Pub. No.: US 2025/0191820 A1
(43) Pub. Date: Jun. 12, 2025

(54) COIL DEVICE

(71) Applicant: TDK Corporation, Tokyo (JP)

(72) Inventors: Taichi WATANABE, Tokyo (JP); Keigo HIGASHIDA, Tokyo (JP); Hanako YOSHINO, Tokyo (JP)

(73) Assignee: TDK Corporation, Tokyo (JP)

(21) Appl. No.: 18/963,931

(22) Filed: Nov. 29, 2024

(30) Foreign Application Priority Data
Dec. 6, 2023 (JP) 2023-206243

(51) Int. Cl. H01F 5/04; H01F 17/04; H01F 27/29

(52) U.S. Cl. CPC H01F 5/04; H01F 17/045; H01F 27/292

(57) ABSTRACT

A coil device includes a drum core, first and second terminals, and first and second coils. The drum core includes a first flange, a second flange, and a winding core connecting them. The first terminals are provided on the first flange. The second terminals are provided on the second flange. The first coil is wound around a winding-core first portion of the winding core and connected to the first and second terminals. The second coil is wound around a winding-core second portion of the winding core and connected to the second and first terminals. A winding-core first side surface and a winding-core second side surface of the winding core are provided respectively with a first-side-surface protrusion and a second-side-surface protrusion. A leading portion of the first coil is connected to one of the second terminals. A leading portion of the second coil is connected to one of the first terminals.

### BACKGROUND OF THE DISCLOSURE

The present invention relates to a coil device that can be used as, for example, a DMI.

A coil device including two coils in a winding core of a core is disclosed (Patent Document 1). In this coil device, the coils are wound on different portions of the same winding core so as to balance the electromagnetic effects generated by the two coils.

In such a coil device, however, excess stray capacitance may occur in the area where a leading wire from one coil approaches the winding portion of the other coil, and there is a problem with degradation of impedance characteristics due to the generation of stray capacitance.

Patent Document 1: JP2006261572 (A)

### BRIEF SUMMARY OF THE INVENTION

The present invention is made in view of the above-mentioned circumstances. It is an object of the invention to provide a coil device capable of preventing generation of stray capacitance.

To achieve the above object, a coil device according to the present invention comprises:
a drum core including:
   a first flange;
   a second flange; and
   a winding core connecting the first flange and the second flange;
first terminals provided on the first flange;
second terminals provided on the second flange;
a first coil wound with multiple turns around a winding-core first portion as a portion of the winding core close to the first flange and having one end connected to one of the first terminals and the other end connected to one of the second terminals; and
a second coil wound with multiple turns around a winding-core second portion as a portion of the winding core close to the second flange and having one end connected to one of the second terminals and the other end connected to one of the first terminals,
   wherein
a winding-core first side surface and a winding-core second side surface of the winding core connecting a winding-core upper surface and a winding-core lower surface are provided respectively with a first-side-surface protrusion and a second-side-surface protrusion arranged between the winding-core first portion and the winding-core second portion on the winding-core first side surface and the winding-core second side surface opposite to the winding-core first side surface,
a leading portion of the first coil led out from the winding-core first portion to one of the second terminals is connected to one of the second terminals after being engaged with a lower end of the first-side-surface protrusion located at a position equal to or higher than the winding-core lower surface or with an upper end of the first-side-surface protrusion located at a position equal to or lower than the winding-core upper surface, and
a leading portion of the second coil led out from the winding-core second portion to one of the first terminals is connected to one of the first terminals after being engaged with an upper end of the second-side-surface protrusion located at a position equal to or lower than the winding-core upper surface or with a lower end of the second-side-surface protrusion located at a position equal to or higher than the winding-core lower surface.

In such a coil device, the leading portion of each coil is engaged with the upper end or the lower end of the first-side-surface protrusion or the second-side-surface protrusion and is thereafter connected to one of the first or second terminals on the opposite side to the winding-core portion of the winding core to be wound. For example, when the winding direction is a right-handed screw direction and the terminal positions are parallel, such a leading portion is engaged with the side-surface protrusion and can thereby be connected to one of the first or second terminals while avoiding passing directly above the winding portion of the other coil, although the leading portion would pass directly above the winding portion of the other coil if the side-surface protrusion did not exist. Also, for example, when the winding direction is a left-handed screw direction and the terminal positions are parallel, the leading portion is engaged with the side-surface protrusion and can thereby be connected to one of the first or second terminals while avoiding passing through the vicinity of the side surface of the winding portion of the other coil, although the leading portion would pass through the vicinity of the side surface of the winding portion of the other coil if the side-surface protrusion did not exist. Note that, when the winding direction is a right-handed screw direction and the terminal positions are cross, it is the same as when the winding direction is a left-handed screw direction and the terminal positions are parallel, and when the winding direction is a left-handed screw direction and the terminal positions are cross, it is the same as when the winding direction is a right-handed screw direction and the terminal positions are parallel. As a result, in the coil device, the leading portion of each coil can pass through a position farther away from the winding portion of the other coil compared to when the side-surface protrusions do not exist, and the generation of stray capacitance can be prevented. Also, since the upper end of the side-surface protrusion is at a position equal to or lower than the winding-core upper surface and the lower end of the side-surface protrusion is at a position equal to or higher than the winding-core lower surface, it is possible to prevent DC resistance (Rdc) from increasing due to the engagement of the coils with the upper and lower ends of the side-surface protrusions.

Also, for example, the coil device may further comprise a plate core disposed above the drum core and connecting upper surfaces of the first flange and the second flange.

In the coil device including the plate core, a closed magnetic circuit can be formed with a simple structure. Moreover, since the leading portion of each coil is engaged with the upper or lower end of the first-side-surface protrusion or the second-side-surface protrusion, the leading portion does not need to pass through the narrow space between the plate core and the winding portion of the other coil. This is advantageous for low profile.

Also, for example, a second-coil-connection first terminal, one of the first terminals connectable with the leading portion of the second coil, may be disposed closer to the winding-core second side surface than to the winding-core first side surface, and a first-coil-connection second terminal, one of the second terminals connectable with the leading portion of the first coil, may be disposed closer to the winding-core first side surface than to the winding-core second side surface.

When the first or second terminal connectable with the leading portion of each coil is disposed close to the winding-core first or second side surface formed with the first-side-surface protrusion or the second-side-surface protrusion engaged with each leading portion, the leading portion can be connected to the first or second terminal while avoiding passing directly above the winding portion of the other coil.

Also, for example, the leading portion of the first coil may be connected to the second terminal after being engaged with a lower end of the first-side-surface protrusion located at a position higher than the winding-core lower surface, and the leading portion of the second coil may be connected to the first terminal after being engaged with an upper end of the second-side-surface protrusion located at a position lower than the winding-core upper surface.

In the coil device in which the first coil and the second coil are wound in opposite directions and the terminals are arranged in parallel, stray capacitance can be reduced effectively with such a configuration.

Also, for example, the number of turns of the second coil wound around the winding-core second portion may be the same as the number of turns of the first coil wound around the winding-core first portion.

Such a coil device can be favorably used as a noise filter such as a DMI and common mode coil.

### BRIEF DESCRIPTION OF THE SEVERAL VIEWS OF THE DRAWING

FIG. 1 is a schematic perspective view of a coil device according to an embodiment of the present invention;

FIG. 2 is a front view of a main body of the coil device shown in FIG. 1 as viewed from front;

FIG. 3 is a plan view of a main body of the coil device shown in FIG. 1 as viewed from above;

FIG. 4 is a bottom view of a main body of the coil device shown in FIG. 1 as viewed from below;

FIG. 5 is a rear view of a main body of the coil device shown in FIG. 1 as viewed from rear; and

FIG. 6 is a schematic perspective view of a drum core included in a coil device according to a modified example.

### DETAILED DESCRIPTION OF THE INVENTION

Hereinafter, a coil device according to the present disclosure is described with reference to an embodiment.

As an embodiment of the coil device according to the present disclosure, the overall configuration of a differential mode inductor (DMI) having a function of, for example, a noise filter is described. However, the coil device according to the present disclosure is not limited to those used as differential mode inductors (DMI) and also includes coil devices other than DMIs, such as those used as common mode filters.

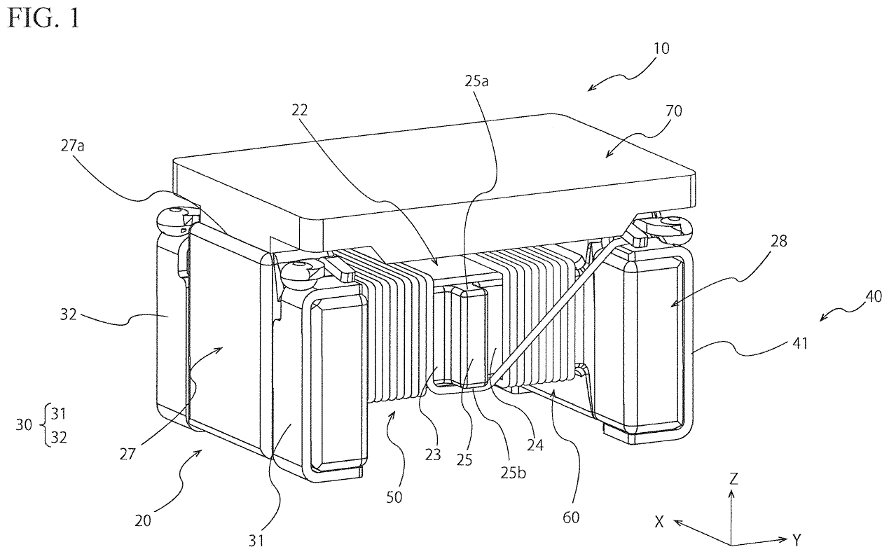

FIG. 1 is a schematic perspective view of a coil device 10 according to an embodiment of the present disclosure. As shown in FIG. 1, the coil device 10 has a generally rectangular parallelepiped shape as a whole and includes a first coil 50, a second coil 60, a drum core 20 including a winding core 22 around which the first coil 50 and the second coil 60 are wound, and a plate core 70. The coil device 10 also includes a plurality of first terminals 30 provided on a first flange 27 of the drum core 20 and a plurality of second terminals 40 provided on a second flange 28.

The coil device 10 has outer dimensions of, for example, 4.3 to 4.7 mm in length in the X-axis direction, 2.6 to 3.0 mm in height in the Z-axis direction, and 3.0 to 3.4 mm in width in the Y-axis direction, but the size of the coil device 10 is not limited to this.

The drum core 20 includes the first flange 27, the second flange 28, and the winding core 22 connecting the first flange 27 and the second flange 28. The winding core 22 extends along the Y-axis. The first flange 27 is provided at one end (negative side in the Y-axis direction) of the winding core 22, and the second flange 28 is provided on the other end (positive side in the Y-axis direction) of the winding core 22. That is, the winding core 22 connects the mutually opposing surfaces of the first flange 27 and the second flange 28. Note that, in the present disclosure, the direction from the first flange 27 to the second flange 28 in the winding core 22 may be referred to as the positive direction of the Y-axis, and the opposite direction may be referred to as the negative direction. Also, the direction being perpendicular to a mounting surface of the coil device 10 and extending from the mounting surface toward the winding core 22 and the plate core 70 may be referred to as the positive direction of the Z-axis or as above, and the opposite direction may be referred to as the negative direction of the Z-axis or as below. The X-axis, the Y-axis, and the Z-axis are perpendicular to each other.

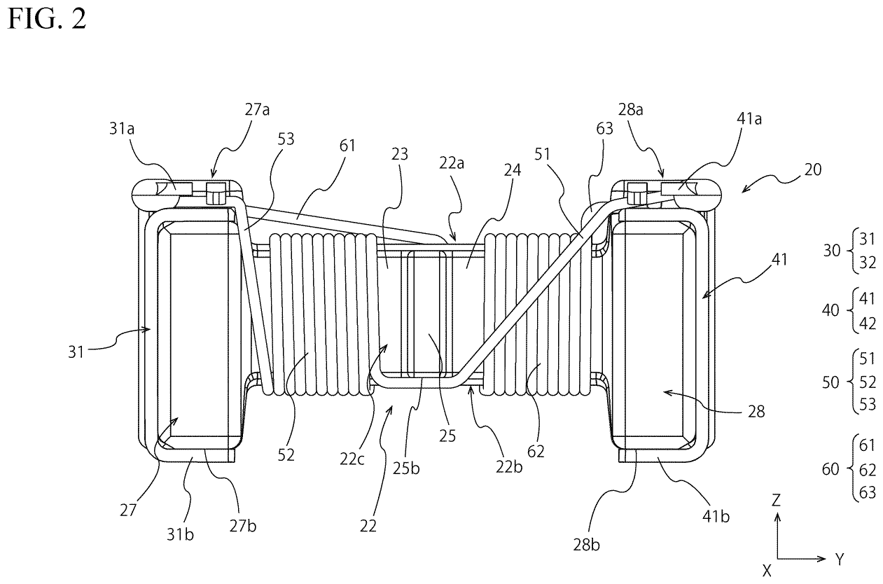

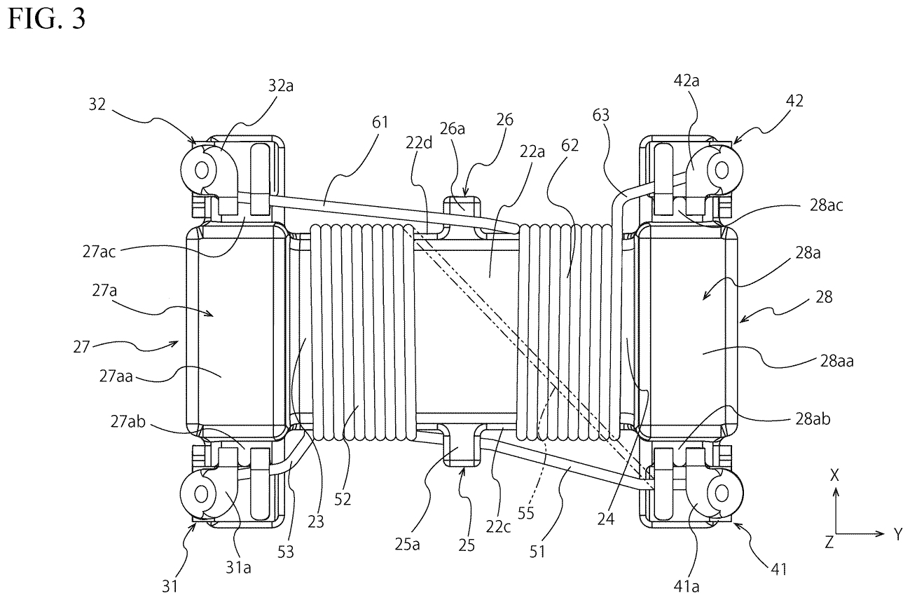

FIG. 2 is a front view of the main body of the coil device 10 shown in FIG. 1 excluding the plate core 70 as viewed from the front, and FIG. 3 is a plan view of the main body of the coil device 10 as viewed from above. As can be seen from FIG. 2 and FIG. 3, the winding core 22 of the drum core 20 has a substantially rectangular parallelepiped outer shape and is substantially rectangular in its YZ cross section. The winding core 22 includes a winding-core upper surface 22a facing above (positive side in the Z-axis direction), a winding-core lower surface 22b facing below (negative side in the Z-axis direction), and a winding-core first side surface 22c and a winding-core second side surface 22d facing lateral (Y-axis direction).

The winding-core first side surface 22c and the winding-core second side surface 22d connect the winding-core upper surface 22a and the winding-core lower surface 22b and face in opposite directions. Note that, in the present disclosure, the direction from the winding-core first side surface 22c to the winding-core second side surface 22d may be referred to as the positive direction of the X-axis, and the opposite direction may be referred to as the negative direction.

As shown in FIG. 2 and FIG. 3, the first flange 27 and the second flange 28 have substantially symmetrical shapes with respect to the winding core 22. As shown in FIG. 1, the first flange 27 and the second flange 28 are substantially quadrangular when viewed from the Y-axis direction and have a substantially rectangular solid three-dimensional shape.

As shown in FIG. 3, a flange upper surface 27a (a surface of the first flange 27 facing above) includes a central protrusion 27aa, a first side recess 27ab disposed on the negative side of the central protrusion 27aa in the X-axis direction, and a second side recess 27ac disposed on the positive side of the central protrusion 27aa in the X-axis direction. When viewed from above, the central protrusion 27aa is disposed on an extension of the winding core 22 and is located at a central part in the X-axis direction. The central protrusion 27aa is located above the first side recess 27ab and the second side recess 27ac.

Similarly to the first flange 27, a flange upper surface 28a (a surface of the second flange 28 facing above) includes a central protrusion 28aa , a first side recess 28ab disposed on the negative side of the central protrusion 28aa in the X-axis direction, and a second side recess 28ac disposed on the positive side of the central protrusion 28aa in the X-axis direction. When viewed from above, the central protrusion 28aa is disposed on an extension of the winding core 22 and is located at a central part in the X-axis direction. The central protrusion 28aa is located above the first side recess 28ab and the second side recess 28ac.

As shown in FIG. 1, the plate core 70 is disposed above the drum core 20. The plate core 70 connects the flange upper surfaces 27a and 28b of the first flange 27 and the second flange 28 of the drum core 20. As shown in FIG. 1, in the coil device 10 according to the embodiment, the plate core 70 connects the central protrusion 27aa of the flange upper surface 27a of the first flange 27 and the central protrusion 28aa of the flange upper surface 28a of the second flange 28.

As shown in FIG. 3, the plurality of first terminals 30 includes a first-coil-connection first terminal 31 and a second-coil-connection first terminal 32. Both of the first-coil-connection first terminal 31 and the second-coil-connection first terminal 32 are provided on the first flange 27. However, the first-coil-connection first terminal 31 is disposed closer to the winding-core first side surface 22c than to the winding-core second side surface 22d, whereas the second-coil-connection first terminal 32 is disposed closer to the winding-core second side surface 22d than to the winding-core first side surface 22c.

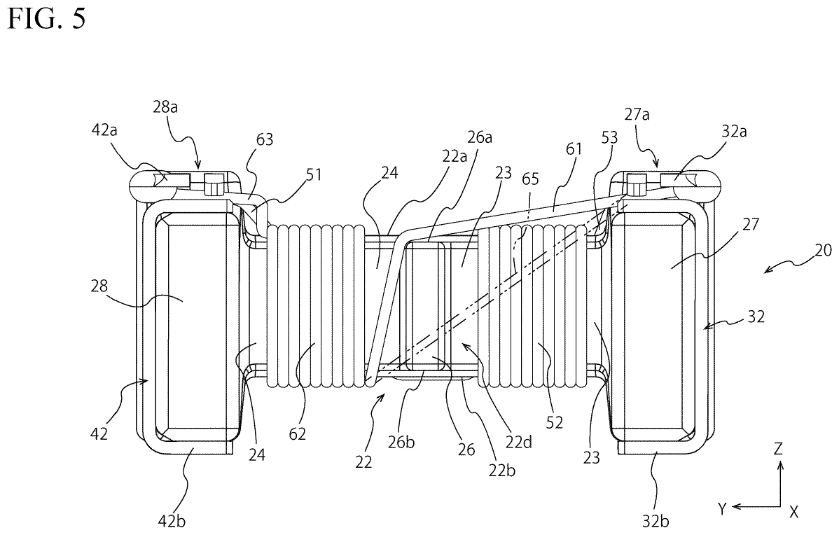

FIG. 5 is a rear view of the main body of the coil device 10 as viewed from rear. As shown in FIG. 2 (front view) and FIG. 5 (rear view), the first-coil-connection first terminal 31 and the second-coil-connection first terminal 32 include: wire connection portions 31a and 32a provided on the flange upper surface 27a of the first flange 27; mounting portions 31b and 32b provided on the flange lower surface 27b of the first flange 27; and connection portions connecting the wire connection portions 31a and 32a and the mounting portions 31b and 32b and arranged on end surfaces of the first flange 27. As shown in FIG. 3, the wire connection portion 31a of the first-coil-connection first terminal 31 is disposed in the first side recess 27ab close to the winding-core first side surface 22c, and the wire connection portion 32a of the second-coil-connection first terminal 32 is disposed in the second side recess 27ac close to the winding-core second side surface 22d.

As shown in FIG. 3, the plurality of second terminals 40 includes a first-coil-connection second terminal 41 and a second-coil-connection second terminal 42. Both of the first-coil-connection second terminal 41 and the second-coil-connection second terminal 42 are provided on the second flange 28. However, the first-coil-connection second terminal 41 is disposed closer to the winding-core first side surface 22c than to the winding-core second side surface 22d, whereas the second-coil-connection second terminal 42 is disposed closer to the winding-core second side surface 22d than to the winding-core first side surface 22c.

As shown in FIG. 2 (front view) and FIG. 5 (rear view), the first-coil-connection second terminal 41 and the second-coil-connection second terminal 42 include: wire connection portions 41a and 42a provided on the flange upper surface 28a of the second flange 28; mounting portions 41b and 42b provided on the flange lower surface 28b of the second flange 28; and connection portions connecting the wire connection portions 41a and 42a and the mounting portions 41b and 42b and provided on end surfaces of the second flange 28. As shown in FIG. 3, the wire connection portion 41a of the first-coil-connection second terminal 41 is disposed in the first side recess 28ab close to the winding-core first side surface 22c, and the wire connection portion 42a of the second-coil-connection second terminal 42 is disposed in the second side recess 28ac close to the winding-core second side surface 22d.

As shown in FIG. 2, the first-coil-connection first terminal 31 provided on the first flange 27 and the first-coil-connection second terminal 41 provided on the second flange 28 are arranged substantially symmetrically with respect to an axis of symmetry extending in the Z-axis direction through the center of the winding core 22. Also, as shown in FIG. 5, the second-coil-connection first terminal 32 provided on the first flange 27 and the second-coil-connection second terminal 42 provided on the second flange 28 are arranged substantially symmetrically with respect to an axis of symmetry extending in the Z-axis direction through the center of the winding core 22.

As shown in FIG. 2 and FIG. 3, the coil device 10 includes two coils of the first coil 50 and the second coil 60. The first coil 50 and the second coil 60 are made of a coated electric wire, etc. The first coil 50 and the second coil 60 are insulated from each other.

As shown in FIG. 2, one end of the first coil 50 is connected to the first-coil-connection first terminal 31 (one of the first terminals 30), and the other end of the first coil 50 is connected to the first-coil-connection second terminal 41 (one of the second terminals 40). The first coil 50 includes a first-coil winding portion 52 wound with multiple turns around a winding-core first portion 23 as a portion of the winding core 22 close to the first flange 27.

In addition to the first-coil winding portion 52, the first coil 50 includes: a leading portion 51 of the first coil 50 led out from the winding-core first portion 23 to the first-coil-connection second terminal 41; and a base leading portion 53 of the first coil 50 led out from the winding-core first portion 23 to the first-coil-connection first terminal 31. The end of the base leading portion 53 (also, one end of the first coil 50) is connected to the wire connection portion 31a of the first-coil-connection first terminal 31. Also, the end of the leading portion 51 (also, the other end of the first coil 50) is connected to the wire connection portion 41a of the first-coil-connection second terminal 41.

As shown in FIG. 1, the wire connection portion 31a of the first-coil-connection first terminal 31 and the wire connection portion 41a of the first-coil-connection second terminal 41 are arranged in the gap between the lower surface of the plate core 70 and the flange upper surface 27a (28a) of the first flange 27 or the second flange 28.

As shown in FIG. 5, one end of the second coil 60 is connected to the second-coil-connection second terminal 42 (one of the second terminals 40), and the other end of the second coil 60 is connected to the second-coil-connection first terminal 32 (one of the first terminals 30). The second coil 60 includes a second-coil winding portion 62 wound with multiple turns around a winding-core second portion 24 as a portion of the winding core 22 close to the second flange 28.

In addition to the second-coil winding portion 62, the second coil 60 includes: a leading portion 61 of the second coil 60 led out from the winding-core second portion 24 to the second-coil-connection first terminal 32; and a base leading portion 63 of the second coil 60 led out from the winding-core second portion 24 to the second-coil-connection second terminal 42. The end of the base leading portion 63 (also, one end of the second coil 60) is connected to the wire connection portion 42a of the second-coil-connection second terminal 42. Also, the end of the leading portion 61 (also, the other end of the second coil 60) is connected to the wire connection portion 32a of the second-coil-connection first terminal 32.

As can be seen from FIG. 1, similarly to the wire connection portions 31a and 41a, the wire connection portion 32a of the second-coil-connection first terminal 32 and the wire connection portion 42a of the second-coil-connection second terminal 42 are arranged in the gap between the lower surface of the plate core 70 and the flange upper surface 27a (28a) of the first flange 27 or the second flange 28.

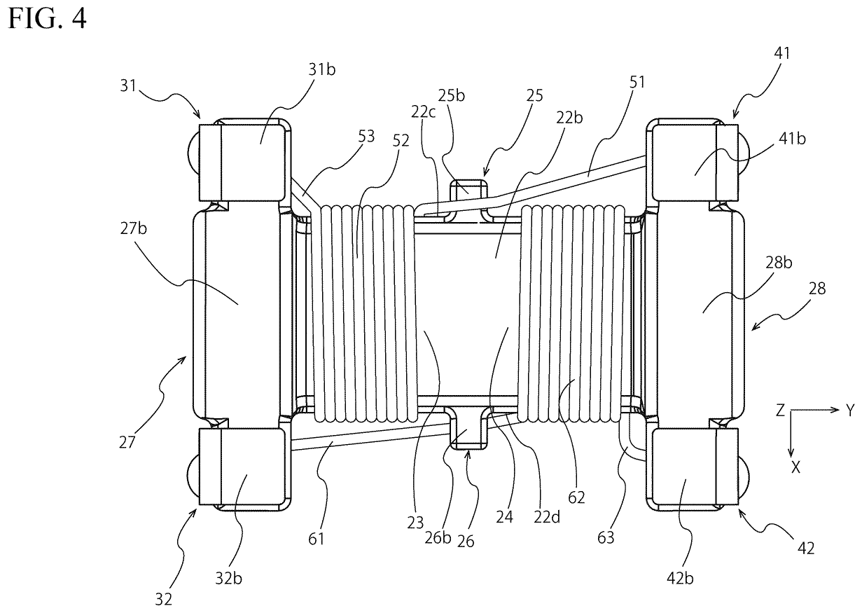

FIG. 4 is a bottom view of the main body of the coil device 10 shown in FIG. 1 excluding the plate core 70. As shown in FIG. 2 to FIG. 5, a first-side-surface protrusion 25 is formed between the winding-core first portion 23 and the winding-core second portion 24 on the winding-core first side surface 22c of the winding core 22. Also, a second-side-surface protrusion 26 is formed between the winding-core first portion 23 and the winding-core second portion 24 on the winding-core second side surface 22d of the winding core 22.

As shown in FIG. 2 to FIG. 4, the first-side-surface protrusion 25 protrudes on the winding-core first side surface 22c toward the negative side of the surface of the winding-core first portion 23 and the winding-core second portion 24 in the X-axis. An upper end 25a of the first-side-surface protrusion 25 is at a position equal to or lower than the winding-core upper surface 22a, and a lower end 25b of the first-side-surface protrusion 25 is at a position equal to or higher than the winding-core lower surface 22b.

As shown in FIG. 3 to FIG. 5, the second-side-surface protrusion 26 protrudes on the winding-core second side surface 22d toward the positive side of the surface of the winding-core first portion 23 and the winding-core second portion 24 in the X-axis. An upper end 26a of the second-side-surface protrusion 26 is at a position equal to or lower than the winding-core upper surface 22a, and a lower end 26b of the second-side-surface protrusion 26 is at a position equal to or higher than the winding-core lower surface 22b.

As shown in FIG. 2, the leading portion 51 of the first coil 50 led out from the winding-core first portion 23 to the first-coil-connection second terminal 41 is led out from the winding-core first portion 23 and is thereafter engaged with the lower end 25b of the first-side-surface protrusion 25 and connected to the first-coil-connection second terminal 41. Also, as shown in FIG. 5, the leading portion 61 of the second coil 60 led out from the winding-core second portion 24 to the second-coil-connection first terminal 32 is led out from the winding-core second portion 24 and is thereafter engaged with the upper end 26a of the second-side-surface protrusion 26 and connected to the second-coil-connection first terminal 32.

As can be seen from FIG. 2 and FIG. 3, the first-coil winding portion 52 of the first coil 50 is wound around the winding-core first portion 23 in a right-handed screw direction (rotating rightward to advance inward). On the other hand, as can be seen from FIG. 3 and FIG. 5, the second-coil winding portion 62 of the second coil 60 is wound around the winding-core second portion 24 in a left-handed screw direction (rotating leftward to advance inward). Since the first coil 50 is wound a right-handed screw direction, the leading portion 51 of the first coil 50 is engaged with the lower end 25b of the first-side-surface protrusion 25 and thereafter connected to the first-coil-connection second terminal 41. On the other hand, since the second coil 60 is wound a left-handed screw direction, the leading portion 61 of the second coil 60 is engaged with the upper end 26a of the second-side-surface protrusion 26 and thereafter connected to the second-coil-connection first terminal 32.

However, the winding direction of the first-coil winding portion 52 of the first coil 50 is not limited to the right-handed screw direction, and the first-coil winding portion 52 of the first coil 50 may be wound in a left-handed screw direction around the winding-core first portion 23. In such a case, the leading portion 51 of the first coil 50 is led out from the winding-core first portion 23 and can thereafter be engaged with the upper end 25a of the first-side-surface protrusion 25 and connected to the first-coil-connection second terminal 41. Preferably, even whether the first coil 50 is wound in a right-handed screw direction or a left-handed screw direction, the first-coil-connection first terminal 31 and the first-coil-connection second terminal 41 connected with the ends of the first coil 50 are arranged on the same side in the X-axis direction, namely, close to the winding-core first side surface 22c.

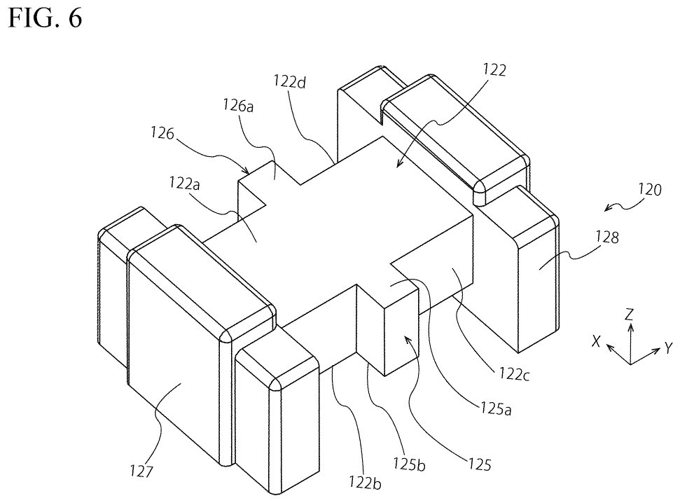

In the coil device 10, the lower end 25b of the first-side-surface protrusion 25 is at a position higher than the winding-core lower surface 22b (see FIG. 2). Thus, the leading portion 51 of the first coil 50 is engaged with the lower end 25b of the first-side-surface protrusion 25 located at a position higher than the winding-core lower surface 22b and is thereafter connected to the first-coil-connection second terminal 41. However, the lower end 25b of the first-side-surface protrusion 25 is not limited to being located higher than the winding-core lower surface 22b, and a lower end 125b of a first-side-surface protrusion 125 may be at the same height as a winding-core lower surface 122b as in a drum core 120 according to a modified example shown in FIG. 6. Likewise, an upper end 125a of the first-side-surface protrusion 125 may be at the same height as a winding-core upper surface 122a.

The winding direction of the second-coil winding portion 62 of the second coil 60 is not limited to the left-handed screw direction, and the second-coil winding portion 62 of the second coil 60 may be wound in a right-handed screw direction around the winding-core second portion 24. In such a case, the leading portion 61 of the second coil 60 is led out from the winding-core second portion 24 and can thereafter be engaged with the lower end 26b of the second-side-surface protrusion 26 and connected to the second-coil-connection first terminal 32. Preferably, even whether the second coil 60 is wound in a right-handed screw direction or a left-handed screw direction, the second-coil-connection first terminal 32 and the second-coil-connection second terminal 42 connected with the ends of the first coil 50 are arranged on the same side in the X-axis direction, namely, close to the winding-core second side surface 22d.

In the coil device 10, the upper end 25a of the second-side-surface protrusion 26 is at a position lower than the winding-core upper surface 22a (see FIG. 5). Thus, the leading portion 61 of the second coil 60 is engaged with the upper end 26a of the second-side-surface protrusion 26 located at a position lower than the winding-core upper surface 22a and is thereafter connected to the second-coil-connection first terminal 32. However, the upper end 26a of the second-side-surface protrusion 26 is not limited to being located lower than the winding-core upper surface 22a, and an upper end 126a of a second-side-surface protrusion 126 may be at the same height as a winding-core upper surface 122a as in a drum core 120 according to a modified example shown in FIG. 6. Likewise, the lower end of the second-side-surface protrusion 126 may be at the same height as the winding-core lower surface 122b.

In the coil device 10, the number of turns of the second coil 60 wound around the winding-core second portion 24 is the same as the number of turns of the first coil 50 wound around the winding-core first portion 23. Such a coil device 10 can be favorably used as a noise filter such as a DMI or common mode coil. However, the number of turns of the first coil 50 and the number of turns of the second coil 60 may be different from each other. Note that, the same number of turns of the first coil 50 and the second coil 60 means that the difference in the number of turns between the first coil 50 and the second coil 60 is less than one turn.

In the coil device 10, as shown in FIG. 1 to FIG. 5, the leading portion 51 (61) of the coil 50 (60) is engaged with the upper end 26a (lower end 25b) of the first-side-surface protrusion 25 (second-side-surface protrusion 26) and is thereafter connected to the first terminal 32 (second terminal 41) on the opposite side to the first portion 23 (second portion 24) of the winding core 22 to be wound. As a result, the leading portion 51 of the first coil 50, whose winding direction is a right-handed screw direction, is engaged with the lower end 25b of the first-side-surface protrusion 25 and can thereby be connected to the first-coil-connection second terminal 41 while avoiding passing directly above the second-coil winding portion 62, although the leading portion 51 of the first coil 50 would pass directly above the second-coil winding portion 62 of the second coil 60 as shown by a two-dot chain line 55 in FIG. 3 if the first-side-surface protrusion 25 did not exist.

In this way, since the leading portion 51 of the first coil 50 avoids passing directly above the second-coil winding portion 62 of the second coil 60, it is possible to reduce the generation of stray capacitance in the coil device 10. This is because the plate core 70 is located above the second-coil winding portion 62, and if the leading portion 51 passes through such a narrow space, the leading portion 51 has no choice but to approach the second-coil winding portion 62. Meanwhile, as shown in FIG. 3, there is relatively more space in the side (negative side in the X-axis direction) of the second-coil winding portion 62 due to the arrangement space of the first-coil-connection first and second terminals 31 and 41. Thus, since the leading portion 51 of the first coil 50 passes through the side of the second-coil winding portion 62, it is possible to increase the distance between the leading portion 51 and the second-coil winding portion 62 and reduce the generation of stray capacitance.

As shown in FIG. 3, when the main body of the coil device 10 is viewed from above, it is preferable from the viewpoint of reducing the generation of stray capacitance that: the leading portion 51 of the first coil 50 does not overlap with the second-coil winding portion 62; and the leading portion 61 of the second coil 60 does not overlap with the first-coil winding portion 52.

The leading portion 61 of the second coil 60, whose winding direction is a left-handed screw direction, is engaged with the upper end 26a of the second-side-surface protrusion 26 and can thereby be connected to the second-coil-connection first terminal 32 while avoiding passing through the vicinity of the first-coil winding portion 52 as much as possible, although the leading portion 61 of the second coil 60 would pass through the side of the first-coil winding portion 52 of the first coil 50 as shown by a dotted line 65 in FIG. 5 if the second-side-surface protrusion 26 did not exist.

In this way, since the leading portion 61 of the second coil 60 avoids passing through the vicinity of the side of the first-coil winding portion 52 of the first coil 50 as much as possible, it is possible to reduce the generation of stray capacitance in the coil device 10. Since the side space of the first-coil winding portion 52 is larger than the space above the first-coil winding portion 52, however, even if the second-side-surface protrusion 26 did not exist, the problem would be smaller than if the first-side-surface protrusion 25 did not exist. For example, the difference in height between the upper end 26a of the second-side-surface protrusion 26 and the winding-core upper surface 22a may be larger than that shown in FIG. 5.

Since the lower end 25b of the first-side-surface protrusion 25 is at a position equal to or higher than the winding-core lower surface 22b and the upper end 26a of the second-side-surface protrusion 26 is at a position equal to or lower than the winding-core upper surface 22a, the first and second coils 50 and 60 are engaged with the upper and lower ends of the side-surface protrusions 25 and 26, and it is thereby possible to prevent a problem in which the DC resistance (Rdc) increases. This is because if the lower end 25b of the first-side-surface protrusion 25 is lower than the winding-core lower surface 22b and the upper end 26a of the second-side-surface protrusion 26 is higher than the winding-core upper surface 22a, the first and second coils 50 and 60 are partly separated from the winding core 22 near the engagement positions with these protrusions, and the first and second coils 50 and 60 have more parts that make only a little contribution to the performance of the coil device 10.

In the coil device 10, since the plate core 70 is included, a closed magnetic circuit can be formed with a simple structure. Moreover, since the leading portions 51 and 61 do not pass between the plate core 70 and the first and second-coil winding portions 52 and 62, the low profile can be achieved by narrowing the gap between the plate core 70 and the first and second-coil winding portions 52 and 62.

As shown in FIG. 3, the leading portion 51 of the first coil 50 is engaged with the first-side-surface protrusion 25 formed on the winding-core first side surface 22c close to the first-coil-connection second terminal 41 connectable with the end of the leading portion 51. Meanwhile, the leading portion 61 of the second coil 60 is engaged with the second-side-surface protrusion 26 formed on the winding-core second side surface 22d close to the second-coil-connection first terminal 32 connectable with the end of the leading portion 61. That is, the first-coil-connection second terminal 41 (second-coil-connection first terminal 32) connectable with the leading portion 51 (61) and the first-side-surface protrusion 25 (second-side-surface protrusion 26) connectable with the leading portion 51 (61) are arranged on the same side with respect to the winding central axis. Thus, the leading portion 51 (61) is prevented from passing directly above the winding portion of the other coil different from the coil of the leading portion 51 (61), and it is possible to effectively prevent the generation of stray capacitance.

### Method of Manufacturing Coil Device 10 Next, a method of manufacturing a coil device 10 according to an embodiment of the present invention is described specifically.

In the manufacture of the coil device 10, first, a drum core 20, a plate core 70, a wire (coated conductive wire) for a first coil 50 and a second coil 60, a plurality of first terminals 30, and a plurality of second terminals 40 are prepared. The drum core 20 and the plate core 70 are made of different magnetic members. The drum core 20 and the plate core 70 are preferably made of the same material, but may be made of different magnetic materials.

Examples of the magnetic material include magnetic materials with relatively high magnetic permeability, such as Ni-Zn based ferrite, Mn—Zn based ferrite, and metallic magnetic materials, and powders of these magnetic materials are molded and sintered so as to produce the drum core 20 and plate core 70. In the drum core 20, a winding core 22, a first-side-surface protrusion 25, a second-side-surface protrusion 26, a first flange 27, and a second flange 28 are integrally formed.

Next, a first-coil-connection first terminal 31 and a second-coil-connection first terminal 32 constituting the plurality of first terminals 30 are attached to the first flange 27. Also, a first-coil-connection second terminal 41 and a second-coil-connection second terminal 42 constituting the plurality of second terminals 40 are attached to the second flange 28. At this time, a non-conductive adhesive may be interposed between the terminals and the flanges for bonding.

The first terminal 30 and the second terminal 40 are formed into the shape shown in FIG. 1, etc. by bending a band-shaped metal plate having a main component of copper alloy, such as phosphor bronze and brass, phosphorus, copper, tin, iron, zinc, or the like. A known plating layer of nickel, tin, etc. may be formed on the surface of the terminal 31 (32, 41, 42) opposite to the side facing the flange. Note that, the terminals are not limited to a metal plate and may be formed by applying a metal paste to the flange and baking it.

Next, as shown in FIG. 1, the wire as a raw material of the first coil 50 is wound with a predetermined number of turns around a winding-core first portion 23 to form a first-coil winding portion 52 of the first coil 50. For one end of the first coil 50, the end of a base leading portion 53 led out from the first-coil winding portion 52 is fixed to a wire connection portion 31a of the first-coil-connection first terminal 31. For the other end of the first coil 50, a part of a leading portion 51 is engaged with a lower end 25b of the first-side-surface protrusion 25, and the end of the leading portion 51 is fixed to a wire connection portion 41a of the first-coil-connection second terminal 41.

Similarly to the first coil 50, the second coil 60 is formed by winding the wire as a raw material of the second coil 60 with a predetermined number of turns around a winding-core second portion 24 to form a second-coil winding portion 62 of the second coil 60. For one end of the second coil 60, the end of a base leading portion 63 led out from the second-coil winding portion 62 is fixed to a wire connection portion 42a of the second-coil-connection second terminal 42. For the other end of the second coil 60, a part of a leading portion 61 is engaged with an upper end 26a of the second-side-surface protrusion 26, and the end of the leading portion 61 is fixed to a wire connection portion 32a of the second-coil-connection first terminal 32.

In forming the first coil 50 and the second coil 60, the wire can be wound by a known method, such as winding with an automatic winding device and manual winding. The first-coil winding portion 52 and the second-coil winding portion 62 may be formed before the ends of the wire are fixed to the terminals or after either end of the wire is fixed to the terminal, and the formation procedure is not limited.

The method of connecting the ends of the first coil 50 and the second coil 60 to the wire connection portions 31a, 32a, 41a, and 42a of the terminals is not limited and can be laser welding, thermocompression bonding, soldering, or the like.

Finally, the plate core 70 is fixed to the drum core 20 on which the first and second coils 50 and 60 are formed, and the coil device 10 is obtained.

As described above, in the coil device 10 according to the present disclosure, the leading portions 51 and 61 of the coils 50 and 60 are engaged with the lower end 25b of the first-side-surface protrusion 25 and the upper end 26a of the second-side-surface protrusion 26 and are thereafter connected to the first-coil-connection second terminal 41 and the second-coil-connection first terminal 32 on the opposite side to the first and second portions 23 and 24 of the winding core 22 to be wound. Since the leading portions 51 and 61 are engaged with the lower end 25b of the first-side-surface protrusion 25 and the upper end 26a of the second-side-surface protrusion 26, it is possible to increase the distance between the leading portion 51 (61) and the winding portion 52 (62) of the other coil compared to when the first-side-surface protrusion 25 and the second-side-surface protrusion 26 do not exist. Thus, the stray capacitance generated in the coil device 10 can be reduced. In the coil device 10, since the generation of stray capacitance can be reduced, it is also possible to favorably prevent the deterioration of impedance characteristics caused by the generation of stray capacitance.

Hereinabove, the coil device according to the present disclosure is described with reference to an embodiment, but is not limited to the coil device 10 shown in the embodiment. Needless to say, the technical scope of the coil device according to the present disclosure includes coil devices according to various other embodiments and modified examples. For example, the coil device 10 may include a coil other than the first coil 50 and the second coil 60, and each of the first terminal 30 and the second terminal 40 may include three or four or more terminals.

The coil device 10 may not include the plate core 70. Also, the shape of the drum core 20 is not limited to one shown in FIG. 1 to FIG. 5. FIG. 6 is a perspective view of a drum core 120 according to a modified example. Similarly to the drum core 20 shown in FIG. 1, etc., the drum core 120 includes a first flange 127, a second flange 128, a winding core 122, and the like, a first-side-surface protrusion 125 is formed on a winding-core first side surface 122c of the winding core 122, and a second-side-surface protrusion 126 is formed on a winding-core second side surface 122d of the winding core 122.

In the drum core 120, upper ends 125a and 126a and lower ends 125b of the first and second-side-surface protrusions 125 and 126 are at the same height as a winding-core upper surface 122a and a winding-core lower surface 122b, respectively. A coil device using the drum core 120 shown in FIG. 6 instead of the drum core 20 shown in FIG. 1, etc. also demonstrates the same effect as the coil device 10 according to the embodiment. From the viewpoint of reducing the DC resistance of the coil device, however, as in the drum core 20 shown in FIG. 1 etc., it is more preferable that: the upper ends 125a and 126a of the first and second-side-surface protrusions 125 and 126 are located lower than the winding-core upper surface 122a; and the lower ends 125b are located higher than the winding-core lower surface 122b.

### DESCRIPTION OF THE REFERENCE NUMERICAL

10 . . . coil device
20, 120 . . . drum core
22, 122 . . . winding core
23 . . . winding-core first portion
24 . . . winding-core second portion
22a, 122a . . . winding-core upper surface
22b, 122b . . . winding-core lower surface
22c, 122c . . . winding-core first side surface
25, 125 . . . first-side-surface protrusion
25a, 125a . . . upper end
25b, 125b . . . lower end
22d, 122d . . . winding-core second side surface
26, 126 . . . second-side-surface protrusion
26a, 126a . . . upper end
26b . . . lower end
27, 127 . . . first flange
27a . . . flange upper surface
27aa . . . central protrusion
27ab . . . first side recess
27ac . . . second side recess
27b . . . flange lower surface
28, 128 . . . second flange
28a . . . flange upper surface
28aa . . . central protrusion
28ab . . . first side recess
28ac . . . second side recess
28b . . . flange lower surface
30 . . . first terminal
31 . . . first-coil-connection first terminal
31a . . . wire connection portion
31b . . . mounting portion
32 . . . second-coil-connection first terminal
32a . . . wire connection portion
32b . . . mounting portion
40 . . . second terminal
41 . . . first-coil-connection second terminal
41a . . . wire connection portion
41b . . . mounting portion
42 . . . second-coil-connection second terminal
42a . . . wire connection portion
42b . . . mounting portion
50 . . . first coil
51 . . . leading portion
52 . . . first-coil winding portion
53 . . . base leading portion
60 . . . second coil
61 . . . leading portion
62 . . . second-coil winding portion
63 . . . base leading portion
70 . . . plate core

What is claimed is:

1. A coil device comprising:
a drum core including:
a first flange;
a second flange; and
a winding core connecting the first flange and the second flange;
first terminals provided on the first flange;
second terminals provided on the second flange;
a first coil wound with multiple turns around a winding-core first portion as a portion of the winding core close to the first flange and having one end connected to one of the first terminals and the other end connected to one of the second terminals; and
a second coil wound with multiple turns around a winding-core second portion as a portion of the winding core close to the second flange and having one end connected to one of the second terminals and the other end connected to one of the first terminals,
wherein
a winding-core first side surface and a winding-core second side surface of the winding core connecting a winding-core upper surface and a winding-core lower surface are provided respectively with a first-side-surface protrusion and a second-side-surface protrusion arranged between the winding-core first portion and the winding-core second portion on the winding-core first side surface and the winding-core second side surface opposite to the winding-core first side surface,
a leading portion of the first coil led out from the winding-core first portion to one of the second terminals is connected to one of the second terminals after being engaged with a lower end of the first-side-surface protrusion located at a position equal to or higher than the winding-core lower surface or with an upper end of the first-side-surface protrusion located at a position equal to or lower than the winding-core upper surface, and
a leading portion of the second coil led out from the winding-core second portion to one of the first terminals is connected to one of the first terminals after being engaged with an upper end of the second-side-surface protrusion located at a position equal to or lower than the winding-core upper surface or with a lower end of the second-side-surface protrusion located at a position equal to or higher than the winding-core lower surface.

2. The coil device according to claim 1, further comprising a plate core disposed above the drum core and connecting upper surfaces of the first flange and the second flange.

3. The coil device according to claim 1, wherein
a second-coil-connection first terminal, one of the first terminals connectable with the leading portion of the second coil, is disposed closer to the winding-core second side surface than to the winding-core first side surface, and
a first-coil-connection second terminal, one of the second terminals connectable with the leading portion of the first coil, is disposed closer to the winding-core first side surface than to the winding-core second side surface.

4. The coil device according to claim 1, wherein
the leading portion of the first coil is connected to the second terminal after being engaged with a lower end of the first-side-surface protrusion located at a position higher than the winding-core lower surface, and
the leading portion of the second coil is connected to the first terminal after being engaged with an upper end of the second-side-surface protrusion located at a position lower than the winding-core upper surface.

5. The coil device according to claim 1, wherein the number of turns of the second coil wound around the winding-core second portion is the same as the number of turns of the first coil wound around the winding-core first portion.
